(19) United States
(12) Patent Application Publication
(10) Pub. No.: US 2005/0007610 A1
(43) Pub. Date: Jan. 13, 2005

(54) Image processing method of digital images, digital camera and print system

(76) Inventors: Toshiaki Kawase, Minato-ku (JP); Yoshinori Usami, Minato-ku (JP); Susumu Minami, Minato-ku (JP); Toshihiko Narita, Minato-ku (JP)

Correspondence Address: BIRCH STEWART KOLASCH & BIRCH, PO BOX 747, FALLS CHURCH, VA, 22040-0747, US

(21) Appl. No.: 10/882,168

(22) Filed: Jul. 2, 2004

(30) Foreign Application Priority Data
Jul. 7, 2003 (JP) 2003-192824

(51) Int. Cl. H04N 1/40; H04N 1/50; G06K 15/02

(52) U.S. Cl. 358/1.9; 358/1.15; 358/504; 358/406; 358/527

(57) ABSTRACT

An image processing method of digital images comprising the steps of: loading photographic conditions on a photo studio when photographing objects with a digital camera of the photo studio and RAW data before image processing obtained under the photographic conditions; performing to the RAW data a development including the image processing according to image processing conditions and generating processed image data; and obtaining image processing conditions for the development so as to provide a color property and a gradation property intended by the photo studio for an output image based on the processed image data, and storing the image processing conditions and the photographic conditions loaded with the RAW data so as to link the image processing conditions to the photographic conditions.

### BACKGROUND OF THE INVENTION

1. Field of the Invention

The present invention relates to an image processing method of digital images, a digital camera and a print system, and in particular, to a technology to alleviate image processing work and image processing load at photo studios such as a photo studio and a photographing studio and a development station (laboratory).

2. Description of the Related Art

In recent years, at photo studios such as a photo studio and a photographing studio, digital photographing is performed by using a digital camera and thereafter, image processing such as color correction, gradation correction, trimming process and image composition (template composition) is performed to a digital image of which photo print is accepted. And order information such as the number of prints and print sizes is recorded on a medium together with the digital image having undergone the image processing such as an image file in a JPEG (Joint Photographic Experts Group) format, which is then sent to a development station. The development station performs digital printing of the digital image received from the photo studio with a digital printer according to the order information of a user, and delivers the digitally printed photo print to the photo studio.

A proposal has been made as to an image processing apparatus suitably satisfying various performance requirements for the photo print and capable of suitable printing meeting a status of use of the photo print by a print vender and intent of a print creator (Japanese Patent Application Publication No. 2001-218047).

This image processing apparatus comprises a condition setting portion for analyzing image data and setting image processing conditions to be applied to the image data, an image processing portion for performing the image processing according to the image processing conditions set by the condition setting portion, a switching device which comprises a plurality of operation modes according to work objects and switches at least one of processing in the condition setting portion and the image processing performed in the image processing portion according to the operation mode, and an operation mode selection device. It allows creation of the photo print meeting the performance requirements by selecting a suitable operation mode out of the operation modes meeting various requirements for the photo print such as productivity, image quality and uniformity in the image quality of a roll of film. In the image processing performed with a digital camera, gradation and saturation are uniquely set by AE, AWB and color space designation so as to generate the image.

### SUMMARY OF THE INVENTION

A photo studio further performs image processing such as color correction and gradation correction to an image obtained by a digital camera while performing a monitor test and so on by using an image processing apparatus in the studio. There is a problem, however, that this kind of image processing work is cumbersome.

A finished image of a photo print wherein a digital image having undergone the image processing received from the photo studio is printed directly by a digital printer of the studio does not always match with the one monitor-tested. Therefore, there are the cases where the photo print meeting the intent of the photo studio (the photo print which is a preference of the photo studio) cannot be obtained. For that reason, there are the cases where a development station is required to further perform the image processing such as the color correction and gradation correction to the digital image having undergone the image processing received from the photo studio by using the image processing apparatus in the development station before printing it with the digital printer.

In general, each photo studio has a different preference for color and gradation as to a finish of the photo print. Under ordinary circumstances, the development station prints a plurality of test sheets of a sample image by changing image processing conditions in advance so as to acquire the image processing conditions of the color correction and gradation correction meeting the preference of the photo studio in compliance with the intent of the photo studio. On receiving a print order based on the digital image from the photo studio, the development station image-processes the digital image according to the image processing conditions meeting the preference of the photo studio, and then digitally prints it with the digital printer. For that reason, the digital image must be image-processed by changing the image processing conditions for each photo studio, and so there is a problem that it is cumbersome.

The image generated by the digital camera has a finish unique to the camera. And there is a problem that, to correct it to be the image of the preference, its latitude is narrower than a negative image, its range capable of properly correcting the color and gradation is limited, and in particular, its correction range is narrow in the case of the image-processed digital image.

There is also the digital camera capable of directly outputting unprocessed data in color filter arrangement of R, G and B of an imaging device such as a CCD (Charge-Coupled Device) or a CMOS (Complementary Metal-Oxide Semiconductor) of the digital camera (hereinafter referred to as RAW data). The RAW data is ordinarily converted to image data visualizable with a monitor and a hard copy (development) by using a personal computer having image processing software used in the digital camera installed thereon. The RAW data has an advantage that its latitude is wider and it has excellent processability compared to the image data after the development.

Therefore, it is desirable to send the RAW data from the photo studio to the development station so as to have the corrections such as the color correction and gradation correction made by the development station simultaneously with the development. There is a problem, however, that the development is a heavy process and the software for the development is different by camera manufacturers and camera types so that the load for the development station increases.

The present invention has been implemented in consideration of such circumstances, and an object thereof is to provide the image processing method of digital images, digital camera and print system capable of alleviating the image processing load at both the photo studios such as the photo studio and photographing studio and the development station and obtaining the image data and the photo print having the color property and gradation property meeting the intent of the photo studio.

To attain the object, the image processing method of digital images according to a first aspect of the present invention is characterized by comprising the steps of loading photographic conditions on a photo studio when photographing objects with a digital camera of the photo studio and RAW data before image processing obtained under the photographic conditions, performing to the RAW data a development including the image processing according to image processing conditions and generating processed image data, and obtaining image processing conditions for the development so as to provide a color property and a gradation property intended by the photo studio for an output image based on the processed image data, and storing the image processing conditions and the photographic conditions loaded with the RAW data so as to link the image processing conditions to the photographic conditions.

To be more specific, it loads the photographic conditions (luminance of lighting, color temperature and so on) at the photo studio on digital photographing and the RAW data under the photographic conditions. The photographic conditions may be written to a tag of a file of the RAW data. Then, it performs to the RAW data the development including the image processing according to appropriate image processing conditions and generates the processed image data so as to test whether or not the output image (a photo print or a monitor image) based on the processed image data has the color property and gradation property meeting the intent of the photo studio. And it performs the development while changing the image processing conditions and thereby acquires optimum (meeting the preference of the photo studio) image processing conditions so as to store the image processing conditions so as to link the image processing conditions to the photographic conditions at the time. Therefore, once the photographic conditions on digital photographing at the photo studio are determined, the image processing conditions for obtaining the output image meeting the preference of the photo studio can also be determined.

The image processing method of digital images according to a second aspect of the present invention is characterized by comprising the steps of loading photographic conditions on a photo studio when photographing objects with a digital camera of the photo studio and RAW data before image processing obtained under the photographic conditions, performing to the RAW data a development including the image processing according to image processing conditions and generating processed image data, outputting the processed image data to a digital printer to create a photo print, and obtaining image processing conditions for the development so as to provide a color property and a gradation property intended by the photo studio for the created photo print, and storing the image processing conditions and the photographic conditions on the photo studio loaded with the RAW data so as to link the image processing conditions to the photographic conditions on the photo studio.

As with the first aspect of the present invention, the second aspect of the present invention obtains the image processing conditions for the RAW data, and stores the image processing conditions by linking the image processing conditions to the photographic conditions loaded with the RAW data. However, the steps are performed at the development station which receives the RAW data and the photographic conditions from each photo studio, and the image processing conditions linked to the photographic conditions are obtained and stored by each photo studio. The image processing conditions thus stored can be used on the development at each photo studio or development station.

As shown in a third aspect of the present invention, the image processing method of digital images according to the first aspect of the present invention further comprises the steps of registering the image processing conditions with the digital camera and generating a JPEG image in the digital camera according to the registered image processing conditions.

The third aspect of the present invention registers with the digital camera the image processing conditions obtained by the image processing method of digital images according to the first aspect of the present invention, and reflects them on the development to be performed in the digital camera when photographing from a next time so as to directly generate an image file such as JPEG and obtain an intended finish.

The fourth aspect of the present invention is the digital camera used in each photo studio, which is characterized by comprising an imaging device which outputs RAW data, a device which detects or setting photographic conditions on the photo studio, a storage device which stores the image processing conditions linked to the photographic conditions on the photo studio obtained by the image processing method of digital images according to the first aspect of the present invention, and a development device which reads corresponding image processing conditions from the storage device based on the photographic conditions detected or set when photographing, for performing on the RAW data outputted from the imaging device a development including the image processing according to the read image processing conditions and for generating processed image data.

The digital camera reads the image processing conditions from the storage device based on the photographic conditions on digital photographing, and performs to the RAW data on the photographing the development including the image processing according to the read image processing conditions. Therefore, it can generate the image-processed image data meeting the preference of the photo studio.

As shown in a fifth aspect of the present invention, the digital camera according to fourth aspect of the present invention, further comprises a recording device for recording on a recording medium the RAW data outputted from the imaging device and the processed image data generated by the development device. The RAW data has wide latitude and excellent processability compared to the image data after the development. Therefore, in case a proper correction cannot be made with the image data after the development, it can prevent photographing all over again by using the RAW data.

A sixth aspect of the present invention is a print system for sending processed image data from a photo studio to a development station creating a photo print based on the processed image data, which is characterized by comprising the photo studio having an image processing device which performs image processing for proper printing on the processed image data obtained from the digital camera according to fourth aspect of the present invention, and the development station having a digital printer for directly receiving the image data processed by the image processing device and printing an image corresponding to the image data on a printing papers of a predetermined print size.

To be more specific, it can obtain the image-processed image data meeting the preference of the photo studio from the digital camera according to the fourth aspect of the present invention. Therefore, it is no longer necessary for the photo studio to perform the color correction and gradation correction to the image-processed image data so that only the processing such as trimming process, image composition (template composition) and red-eye process is required. While the photo studio can also perform the color correction and gradation correction, the image processing is performed to meet the preference of the photo studio at the stage of the development and so a correction amount can be small enough to be properly corrected. As for the development station, it is no longer necessary to perform the development and the image processing so that the image-processed image data received from each photo studio can be used directly by the digital printer so as to alleviate the load of the development station.

A seventh aspect of the present invention is a print system for sending processed image data from a photo studio to a development station which creates a photo print based on the processed image data, which is characterized by comprising the photo studio having a digital camera for outputting RAW data, a device which detects or sets photographic conditions when photographing with the digital camera at the photo studio, a storage device which stores the image processing conditions linked to the photographic conditions on the photo studio obtained by the image processing method of digital images according to the first aspect of the present invention, a development device which reads corresponding image processing conditions from the storage device based on the photographic conditions detected or set when photographing and performs to the RAW data outputted from the digital camera a development including the image processing according to the read image processing conditions so as to generate processed image data, and an image processing device which performs image processing to properly print the processed image data generated by the development device, and wherein the development station has a digital printer for directly receiving the image data processed by the image processing device and printing an image corresponding to the image data on a printing paper of a predetermined size.

The sixth aspect of the present invention has the development device provided in the digital camera so that the image data having finished the development can be obtained from the digital camera. However, in the seventh aspect of the present invention, the development device is provided in the photo studio to be separate from the digital camera. Therefore, as for the RAW data outputted from the digital camera, the development is performed by the development device in the photo studio by including the image processing according to the image processing conditions corresponding to the photographic conditions.

As shown in an eighth aspect, in the print system according to the sixth aspect of the present invention, the photo studio is characterized by having a backup device which backs up RAW data obtained from the digital camera. Thus, in the case where a desired finish cannot be obtained and a proper correction cannot be made as to the image data having finished the development, it can use the RAW data backed up by the backup device.

As described above, according to the present invention, it is possible for the development station, even in the case where the development station receives the RAW data from the photo studio such as the photo studio or the photographing studio, to perform to the RAW the development including the image processing according to the image processing conditions corresponding to the photographic conditions because the development station has the image processing conditions according to the photographic conditions of each photo studio. And it is feasible, by outputting the image data having undergone the development to the digital printer, to create the photo print having the color property and gradation property meeting the intent of each photo studio.

The digital camera according to the present invention has the storage device which stores the image processing conditions linked to the photographic conditions on the photo studio and reads the image processing conditions suitable to the photo printing at the development station from the storage device according to the photographic conditions when photographing so as to perform to the RAW data when photographing the development including the image processing according to the read image processing conditions. Therefore, it can directly generate the image-processed image data meeting the preference of the photo studio. Thus, it is no longer necessary for the photo studio to perform the color correction and gradation correction to the image-processed image data obtained from the digital camera so that only the processing such as the trimming process, image composition (template composition) and red-eye process is required. Moreover, in the case of performing the color correction and gradation correction, the image processing is performed to meet the preference of the photo studio at the stage of the development and so the correction amount can be small enough to be properly corrected. As for the development station, it is no longer necessary to perform the development and the image processing so that the image-processed image data received from each photo studio can be used directly by the digital printer so as to alleviate the load of the development station.

### BRIEF DESCRIPTION OF THE DRAWINGS

FIG. 1 is a system configuration diagram for describing an image processing method of digital images according to the present invention;

FIG. 2 is a diagram showing an example of a database indicating image processing conditions linked to photographic conditions on a photo studio;

FIG. 3 is a block diagram showing an embodiment of a digital camera according to the present invention; and

FIG. 4 is a diagram used to describe a processing flow from photographing at the photo studio to creation of a photo print at a development station.

### DETAILED DESCRIPTION OF THE PREFERRED EMBODIMENTS

Hereafter, a detailed description will be given in reference to the attached drawings as to preferred embodiments of an image processing method of digital images, a digital camera and a print system according to the present invention.

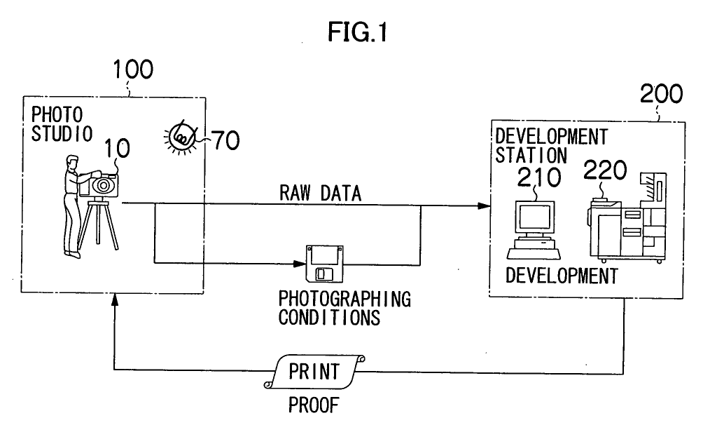

FIG. 1 is a system configuration diagram for describing an image processing method of digital images according to the present invention.

In FIG. 1, reference numeral 100 designates a photo studio, and 200 designates a development station for creating a photo print. The photo studio 100 has a digital camera 10 and a lighting system 70 for digitally photographing a user and so on provided therein.

The digital camera 10 is capable of directly outputting unprocessed data in color filter arrangement of R, G and B of an imaging device such as a CCD (Charge-Coupled device) or a CMOS (Complementary Metal-Oxide Semiconductor) of the digital camera 10 (hereinafter referred to as RAW data). The digital camera 10 also has a function of automatically detecting the luminance and color temperature of the lighting system 70 used on digital photographing or the luminance and color temperature of an object illuminated by the lighting system 70 or a setting device for the sake of manually setting the luminance and color temperature of illumination light. Detailed configuration of the digital camera 10 will be described later.

Next, a description will be given as to the case of obtaining a sample image and so on for the sake of obtaining image processing conditions related to the present invention.

In this case, the photo studio 100 performs photographing under illumination of the lighting system 70 by using the digital camera 10 so as to obtain the RAW data from the digital camera 10 and also obtain photographic conditions indicating the luminance and color temperature of the object at the time of the photographing. And it changes an angle, a light volume and the color temperature of the lighting system 70 or uses a different illumination apparatus, and performs the photographing variously on different photographic conditions to obtain the photographic conditions with the RAW data when photographing each time.

The RAW data and the photographic conditions thus obtained are sent to the development station 200 via a network or via a recording medium such as an MO or a CD-R used to record the RAW data with the digital camera. It is possible either to send the RAW data and the photographic conditions separately by mutually linking them by file names or to record the photographic conditions on a tag of the file having the RAW data recorded therein.

The development station 200 has an image processing apparatus 210 and a digital printer 220 installed therein. The image processing apparatus 210 performs a process of converting the RAW data received from the photo studio 100 via a digital medium to image data visualizable with a monitor and a hard copy and image processing in compliance with appropriate image processing conditions such as color correction and gradation correction (hereafter, this process is referred to as “development”).

Depending on a camera manufacturer and a camera model, the digital camera is different as to the number of pixels, pixel arrangement, color filter arrangement and spectral property of its image pickup device. Consequently, the development of the RAW data is also different from camera to camera. The image processing apparatus 210 has a plurality of development software according to the camera models, and uses the development software corresponding to the camera model which created the RAW data to undergo the development. As the camera model is recorded on the tag of the file of the RAW data, the development software can be selected by using this tag information.

The image data thus having undergone the development is outputted to the digital printer 220.

The digital printer 220 prints an image by performing scan exposure on silver salt color paper with an RGB laser based on the image data having finished the development sent from the image processing apparatus 210. The photo print (proof) created by the development station 200 is tested by a tester of the photo studio 100 as to whether or not a color property, a gradation property and so on of the proof meet a preference. And in the case where its properties do not meet the preference of the photo studio, the proof is created by modifying the image processing conditions on the development of the image processing apparatus 210 according to an instruction (instruction to render it a little more reddish or softer, for instance) from the tester of the photo studio 100. The development station 200 repeats this so as to acquire the image processing conditions for the sake of creating the photo print satisfying the tester of the photo studio 100.

The development station 200 obtains the image processing conditions as to each photo studio and each photographic condition, and stores and manages them in a database and so on.

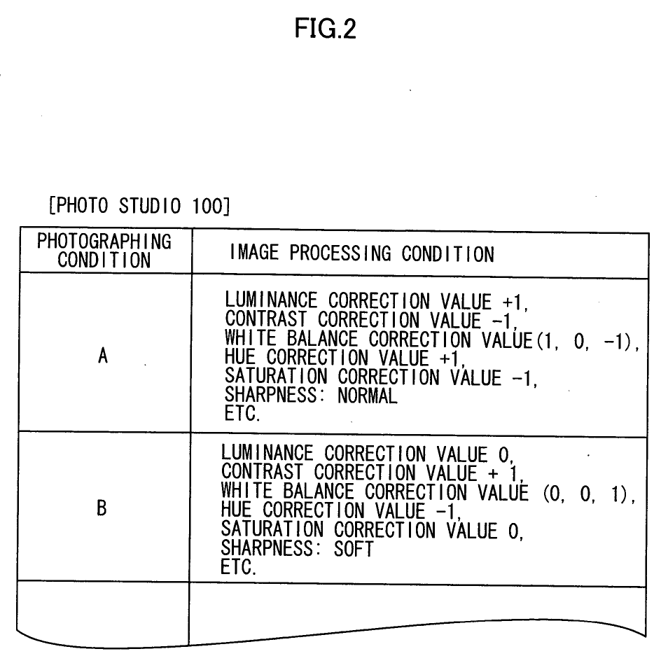

FIG. 2 shows an example of the database indicating the image processing conditions linked to photographic conditions A, B . . . of the photo studio 100. As shown in FIG. 2, it is possible, as for the RAW data obtained when photographing on the photographic condition A of the photo studio 100, to perform the development including the image processing in compliance with the image processing conditions wherein a luminance correction value is +1, a contrast correction value is −1, a white balance correction value for each of the R, G and B data is (1, 0 and −1), a hue correction value is +1, a saturation correction value is −1, and sharpness (edge enhancement) is normal and output the image data after the development to the digital printer 220 so as to obtain the photo print meeting the preference of the photo studio 100.

According to this embodiment, the development station 200 receives the sample image from the photo studio 100 in order to acquire the image processing conditions. However, it may also be the RAW data of which print was actually ordered. Even in this case, it can receive the RAW data and its photographic conditions and accumulate the image processing conditions on creating the photo print satisfying the photo studio 100 as to each photographic condition so as to acquire the image processing conditions for the photo studio 100.

As for kinds of the image processing conditions and the correction values and so on, they are not limited to those shown in FIG. 2 but need to be the kinds and correction values which can be handled by the software for performing the development to the RAW data of the digital cameras. For instance, in the case where a tone curve, a gamma characteristic and a knee characteristic can be designated, they are designated as the image processing conditions.

As described above, the development station 200 obtains the image processing conditions as to each photo studio and each photographic condition, and stores and manages them in a database and so on. Thus, in the case of receiving the RAW data and the photographic conditions on accepting a print order from each photo studio, the development station 200 can perform to the received RAW data the development including the image processing in compliance with appropriate image processing conditions so as to create the photo print meeting the preference of each photo studio.

As for the development of the RAW data, there is a problem that its load is heavy and print creation delays for the development when printing at the development station 200 is busy. It is desirable that the development station 200 receive from each photo studio an image file (an image file in a JPEG format, for instance) having the image data having finished the development recorded therein. Therefore, it is possible, as to each photo studio, to register the image processing conditions as to each photographic condition with the digital camera and reflect them on the image processing performed in the camera so as to directly generate an image file such as JPEG and obtain an intended finish.

Next, a description will be given as to the digital camera 10 capable of outputting the image data having finished the development which allows creation of the photo print meeting the preference of each photo studio at the development station 200.

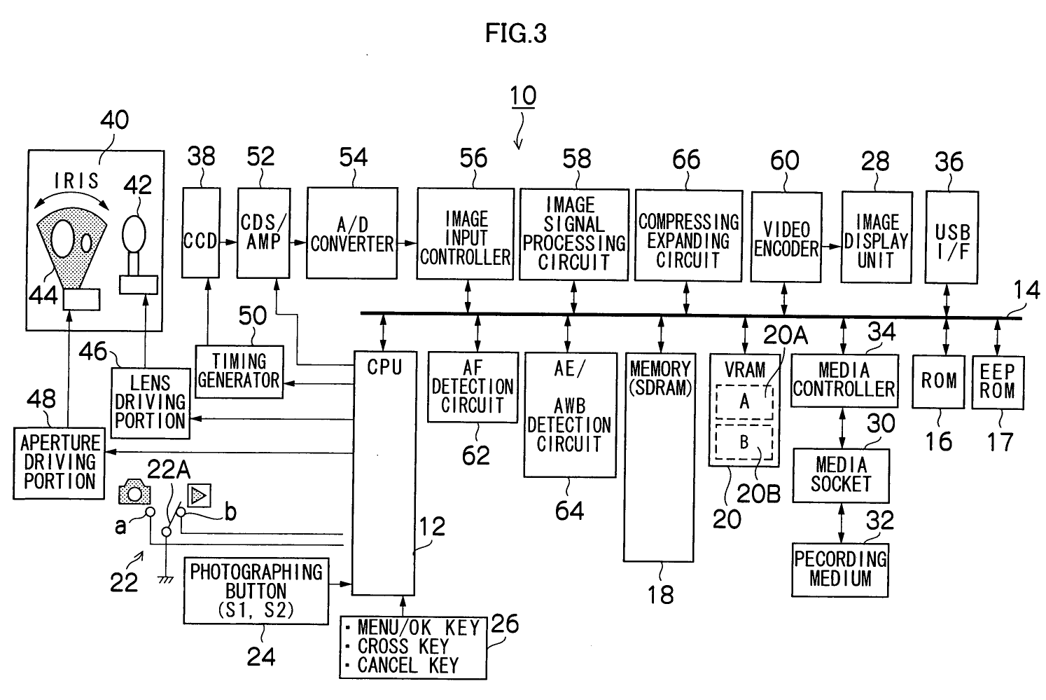

FIG. 3 is a block diagram showing the embodiment of the digital camera 10 according to the present invention.

Operation of the digital camera 10 in its entirety is integrally controlled by a central processing unit (CPU) 12. The CPU 12 functions as a control device which controls this camera system according to a predetermined program and also functions as a calculation device which performs various kinds of calculation such as automatic exposure (AE) calculation, automatic focusing (AF) calculation and white balance (WB) adjustment calculation.

An ROM 16 connected to the CPU 12 via a bus 14 has the program to be executed by the CPU 12 and various kinds of data necessary for control stored therein. An EEPROM 17 has CCD pixel defect information, various constants and information relating to camera operation and the image processing conditions according to the photographic conditions relating to the present invention.

Here, the image processing conditions according to the photographic conditions are those for the photo studio 100 created by the development station 200 as shown in FIG. 2, and are receivable from the development station 200 via a recording medium 32 and so on. The image processing conditions for the photo studio 100 thus received are written to the EEPROM 17 by using a hidden mode for writing the image processing conditions to the EEPROM 17. A method of writing the image processing conditions to the EEPROM 17 is not limited to this embodiment.

A memory (SDRAM) 18 is used as a program expansion area and a calculation work area of the CPU 12, and is also used as a temporary storage area of the image data. A VRAM 20 is a temporary memory used in the image data, and includes an A area 20A and a B area 20B. It can share the memory 18 and the VRAM 20.

The digital camera 10 has a mode selection switch 22, a photographing button 24, and besides, an operation devices 26 such as a menu/OK key, a cross key and a cancel key provided thereon. Signals from the various operation portions (22 to 26) are sent to the CPU 12. The CPU 12 controls circuits of the digital camera 10 based on input signals, and performs lens drive control, photographing operation control, image processing control, image data recording and reproduction control, display control of an image display apparatus 28 and so on for instance.

The mode selection switch 22 is the operation device which switches between a photographing mode and a reproduction mode. If the mode selection switch 22 is operated to connect a movable armature 22A to a contact a, the signal is sent to the CPU 12 so that the digital camera 10 is set in the photographing mode. If the movable armature 22A is connected to a contact b, the digital camera 10 is set in the reproduction mode to reproduce a recorded image.

The photographing button 24 is an operation button to input an instruction to start the photographing, and is comprised of two-stroke switches having an S1 switch to be on when half pushed and an S2 switch to be on when fully pushed.

The menu/OK key is an operation key having a function as a menu button of providing an instruction to display a menu on a screen of the image display apparatus 28 as well as a function as an OK button of providing an instruction to determine and execute selected contents. The cross key is the operation portion to input four-way instructions of right, left, up and down, and functions as a button (cursor-moving operation device) to select an item from the menu and provide an instruction for selection of various set-up items. An up/down key of the cross key functions as a zoom switch when photographing or a reproduction zoom switch on reproduction. A right/left key functions as a frame advance (forward/backward advance) button on reproduction. The cancel key is used when erasing a desired subject, canceling instruction contents or returning to an immediately preceding operation state.

The image display apparatus 28 is comprised of a liquid crystal display capable of color display. The image display apparatus 28 can be used as an electronic finder for a field angle check when photographing and also as a device which reproduces and displays a recorded image. And the image display apparatus 28 is also used as a display screen for a user interface, and so it has the information such as menu information, choices and set-up contents displayed thereon as required.

The digital camera 10 has a media socket (media mounting portion) 30 on which the recording medium 32 is mountable. The form of the recording medium is not especially limited, and it can use various media such as semiconductor memory cards represented by xD-PictureCard (trademark) and SmartMedia (trademark), a portable hard disk, a magnetic disk, an optical disk and a magnet-optical disk.

A media controller 34 performs signal conversion required to deliver and receive input-output signals suited to the recording medium 32 mounted on the media socket 30.

The digital camera 10 comprises a USB interface portion 36 as a communication device which connects it to an external apparatus such as a personal computer. It can connect the digital camera 10 to the external apparatus by using a USB cable not shown so as to deliver and receive data to and from the external apparatus. The USB interface portion 36 may also be another I/F (SCSI, IEEE1394, wireless LAN and so on).

Next, a photographing function of the digital camera 10 will be described.

If the photographing mode is selected by the mode selection switch 22, power is supplied to an image pickup portion including a color CCD solid state imaging device (hereafter, described as CCD) 38 so that the photographing becomes possible.

A lens unit 40 is an optical unit including photographing lenses 42 including a focus lens and a mechanical shutter 44 also used as an aperture. The lens unit 40 is electrically operated by a lens drive portion 46 and an aperture drive portion 48 controlled by the CPU 12 so as to perform zoom control, focus control and iris control.

If the photographing button 24 is half pushed, the digital camera 10 starts AE and AF processes.

To be more specific, the light having passed through the lens unit 40 is focused on a light-receptive surface of the CCD 38. A large number of photodiodes (light-sensitive elements) are two-dimensionally arranged on the light-receptive surface of the CCD 38, where elementary-color filters in red (R), green (G) and blue (B) are placed in a predetermined array structure (Bayer, G stripe and so on) correspondingly to the photodiodes. And the CCD 38 has an electronic shutter function of controlling charge storage time (shutter speed) of each photodiode. The CPU 12 controls the charge storage time on the CCD 38 via a timing generator 50.

An object image focused on the light-receptive surface of the CCD 38 is converted to a signal charge of an amount according to an incident light volume by each photodiode. The signal charge accumulated in each photodiode is sequentially read as a voltage signal (image signal) according to the signal charge based on a drive pulse given from the timing generator 50 in compliance with the instructions of the CPU 12.

The signal outputted from the CCD 38 is sent to an analog process portion (CDS/AMP) 52, where the RGB signals of each pixel undergo a sampling hold (relative double sampling process) and are amplified and then added to an A/D converter 54. The dot sequential RGB signals converted to digital signals by the A/D converter 54 are sent to an AF detection circuit 62 and an AE/AWB detection circuit 64 via an image input controller 56.

The AE/AWB detection circuit 64 divides one screen into a plurality of areas (16×16 for instance) to include a circuit for integrating the RGB signals in each divided area so as to provide an integrated value thereof to the CPU 12. The CPU 12 detects the luminance of the object (object luminance) based on the integrated value obtained from the AE/AWB detection circuit 64, and calculates an exposure value suitable for the photographing (photographing EV value). An aperture value and the shutter speed are determined according to the obtained exposure value and a predetermined program diagram, and the CPU 12 accordingly controls the electronic shutter of the CCD 38 and the iris so as to obtain a proper exposure amount.

On white balance adjustment, the AE/AWB detection circuit 64 calculates average integrated values by the colors of the RGB signals for each of the divided areas, and detects the color temperature of the object (or determines a light source type corresponding to the color temperature) based on the integrated values of R, G and B.

The CPU 12 also reads a corresponding image processing condition from the EEPROM 17 based on the photographic conditions indicating the luminance and color temperature of the object obtained from the AE/AWB detection circuit 64, and sets the read image processing condition as a processing condition parameter value in an image signal processing circuit 58.

As for the AF control in the digital camera 10, a contrast AF for moving a focusing lens (a movable lens contributing to the focus adjustment of a lens optical system constituting the photographing lenses 42) so that a high-frequency component of a G signal of a picture signal becomes maximum is applied for instance. To be more specific, the AF detection circuit 62 is comprised of a high-pass filter for passing only the high-frequency component of the G signal, an absolute value rendering portion, an AF area extraction portion for cutting the signal in a focus subject area preset in the screen (central portion of the screen for instance) and an integration portion for integrating absolute value data in an AF area.

The data on the integrated values obtained in the AF detection circuit 62 is posted to the CPU 12. The CPU 12 calculates focus evaluation values (AF evaluation values) at a plurality of AF detection points while moving the focusing lens by controlling the lens drive portion 46, and determines a lens position at which the evaluation value becomes maximum to be a focusing position. And it controls the lens drive portion 46 to move the focusing lens to the obtained focusing position.

If the photographing button 24 is fully pushed, photographing operation for recording starts, and the dot sequential R, G and B data (RAW data) is sent to the memory 18 from the CCD 38 via the analog process portion 52, the A/D converter 54 and the image input controller 56.

The image signal processing circuit 58 processes the RAW data stored in the memory 18 according to the instruction of the CPU 12 and the image processing condition read from the EEPROM 17 based on the photographic conditions. To be more specific, the image signal processing circuit 58 functions as an image processing device including a synchronization circuit (a processing circuit which interpolates a spatial displacement of a color signal in conjunction with a color filter arrangement of a single-panel CCD to convert the color signal to a synchronous system), a white balance correction circuit, a gamma correction circuit, a profile correction circuit, a luminance and color difference signal generation circuit and so on. It performs the development including the image processing in compliance with the image processing conditions while exploiting the memory 18 according to a command from the CPU 12.

A Y/C signal having undergone the development in the image signal processing circuit 58 and converted from the G and B data to a luminance signal (Y signal) and a color difference signal (Cr or Cb signal) by the luminance and color difference signal generation circuit is stored in the memory 18. The original RAW data remains in the memory 18.

The Y/C signal stored in the memory 18 is compressed according to a JPEG format by a compressing/expanding circuit 66, and then is recorded on the recording medium 32 via the media controller 34. The RAW data stored in the memory 18 is also recorded simultaneously as a RAW file.

In the case of monitor-outputting a shot image to the image display apparatus 28, the image data is read from the VRAM 20, and is sent to a video encoder 60 via the bus 14. The video encoder 60 converts the inputted Y/C signal to a signal for display of a predetermined method (a color composite picture signal of an NTSC method for instance) and outputs it to the image display apparatus 28.

To be more specific, the image data representing the image of one frame is alternately rewritten in the A area 20A and B area 20B of the VRAM 20 by the image signal outputted from the CCD 38. Of the A area 20A and B area 20B of the VRAM 20, written image data is read from the area other than the area having the image data rewritten. Thus, the image data in the VRAM 20 is periodically rewritten, and the picture signal generated from the image data is supplied to the image display apparatus 28 so that the image just being taken is displayed on the image display apparatus 28 in real time. A photographer can check a photographing field angle with the image (through-movie picture) displayed on the image display apparatus 28.

If the reproduction mode is selected by the mode selection switch 22, compressed data of a final image file (lastly recorded file) recorded on the recording medium 32 is read. The read image-compressed data is expanded to an uncompressed Y/C signal via the compressing/expanding circuit 66 and is converted to the signal for display via the image signal processing circuit 58 and the video encoder 60 so as to be outputted to the image display apparatus 28 thereafter. Thus, the image contents of the file are displayed on the screen of the image display apparatus 28.

It can switch the file to be reproduced (forward/backward frame advance) by operating the right key or the left key of the cross key during the reproduction of one frame of a static image. The image file at a frame-advanced position is read from the recording medium 32, and the static image is reproduced and displayed on the image display apparatus 28 as described above.

The digital camera 10 of the above configuration is capable of obtaining the image data having finished the development (image data in the JPEG format) for the sake of creating the photo print meeting the preference of the photo studio.

Next, a description will be given as to a processing flow from the photographing at the photo studio 100 to the creation of the photo print at the development station 200.

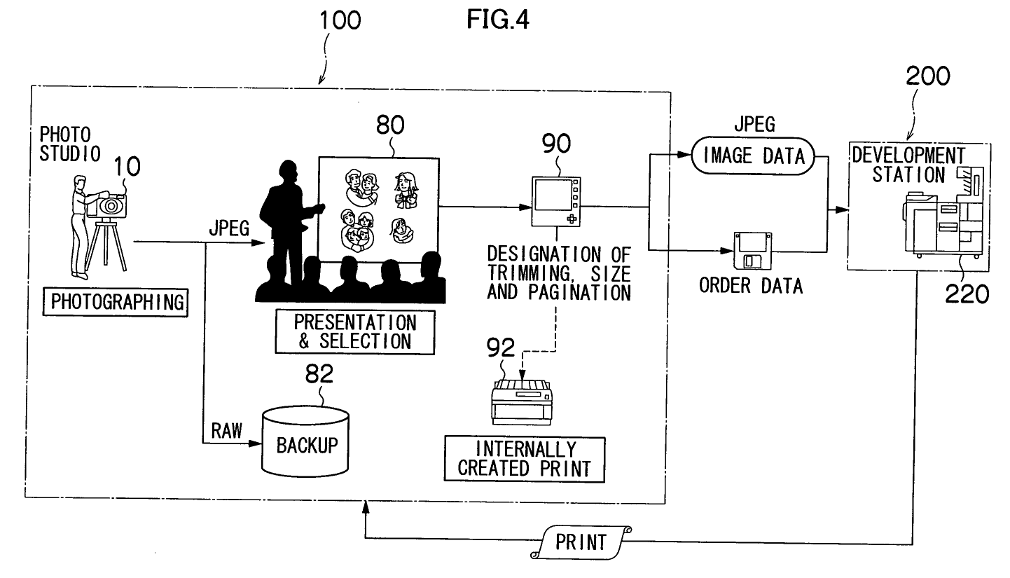

As shown in FIG. 4, the photo studio 100 has the digital camera 10 described in FIG. 3, a digital image reproducing apparatus including a display 80, a large-capacity backup apparatus 82 such as a hard disk unit, an image processing apparatus 90 and a digital printer 92 provided therein.

As described above, the digital camera 10 can record the JPEG image data and the RAW data having finished the development on the recording medium 32. The RAW data recorded on the recording medium 32 after finishing the photographing is stored in the backup apparatus 82.

The JPEG image data (the image data having finished the development) is used for a presentation to have the image for the photo printing selected by the user. To be more specific, the image data having finished the development is reproduced by the reproducing apparatus to display it on the display 80.

The image data having finished the development (having been JPEG-optimized from the RAW data) corresponding to the image selected by the user (the image for which a print order has been accepted) by implementing the presentation is sent to the image processing apparatus 90.

The image processing apparatus 90 is equipped with the image processing device (including image processing software) which performs the image processing for the sake of properly printing the inputted image data having finished the development and the operation device which specifies a trimming range, a print size, the number of prints and so on. An operator can operate the image processing apparatus 90 to perform various kinds of processing such as trimming process, image composition (template composition), red-eye process, beautiful skin process, color correction and gradation correction to the image data having finished the development.

The image data having finished the development to be sent to the image processing apparatus 90 has been processed in the digital camera 10 to be able to obtain the color property and gradation property meeting the preference of the photo studio 100. Therefore, the image processing apparatus 90 does not need to perform the color correction, gradation correction and so on to the image data having finished the development. Nevertheless, it is also possible to further perform the color correction, gradation correction and so on here. It is also possible, if necessary, to perform redevelopment, correction and so on based on the backed-up RAW data.

The image data processed by the image processing apparatus 90 is recorded in the JPEG format on the recording medium (an MO, a CD-R or a memory card for instance), and the order information such as the number of prints and print size is recorded on the same or another recording medium and is sent to the development station 200.

The development station 200 digitally prints the image data in the JPEG format received from the photo studio 100 with the digital printer 220 according to the order information of the user, and delivers this digitally printed photo print 230 to the photo studio 100. There are also the cases where it is printed by the digital printer 92 in the photo studio 100 rather than the digital printer 220 of the development station 200. In such cases, however, it is not possible, due to differences in printer characteristics and so on, to create the photo print having the color property and gradation property meeting the preference of the photo studio 100 so that it is necessary to perform the color correction, gradation correction and so on with the image processing apparatus 90.

According to this embodiment, the photographic conditions indicating the luminance and color temperature of the object are detected based on the RGB signals taken in when the photographing button 24 is half pushed. It is also possible, however, to detect the photographic conditions based on the RAW data taken in when the photographing button 24 is fully pushed. It is also possible to measure the photographic conditions with an external photometric device or a color temperature detection device separate from the digital camera 10. Furthermore, it is also possible, in the case of the digital camera capable of manually setting the photographic conditions, to use the set photographic conditions for the image processing and so on.

According to this embodiment, the RAW data undergoes the development including the image processing according to the image processing conditions corresponding to the photographic conditions when photographing in the digital camera 10. It is also possible, however, to provide the function of the development of the digital camera 10 to the image processing apparatus 90 in the photo studio 100.

1. An image processing method of digital images comprising the steps of:
loading photographic conditions on a photo studio when photographing objects with a digital camera of the photo studio and RAW data before image processing obtained under the photographic conditions;
performing to the RAW data a development including the image processing according to image processing conditions and generating processed image data; and
obtaining image processing conditions for the development so as to provide a color property and a gradation property intended by the photo studio for an output image based on the processed image data, and storing the image processing conditions and the photographic conditions loaded with the RAW data so as to link the image processing conditions to the photographic conditions.

2. An image processing method of digital images comprising the steps of:
loading photographic conditions on a photo studio when photographing objects with a digital camera of the photo studio and RAW data before image processing obtained under the photographic conditions;
performing to the RAW data a development including the image processing according to image processing conditions and generating processed image data;
outputting the processed image data to a digital printer to create a photo print; and
obtaining image processing conditions for the development so as to provide a color property and a gradation property intended by the photo studio for the created photo print, and storing the image processing conditions and the photographic conditions on the photo studio loaded with the RAW data so as to link the image processing conditions to the photographic conditions on the photo studio.

3. The image processing method of digital images according to claim 1, further comprising the steps of:
registering the image processing conditions with the digital camera; and
generating a JPEG image in the digital camera according to the registered image processing conditions.

4. A digital camera used in a photo studio, comprising:
an imaging device which outputs RAW data;
a device which detects or setting photographic conditions on the photo studio;
a storage device which stores the image processing conditions linked to the photographic conditions on the photo studio obtained by the image processing method of digital images according to claim 1; and
a development device which reads corresponding image processing conditions from the storage device based on the photographic conditions detected or set when photographing, for performing on the RAW data outputted from the imaging device a development including the image processing according to the read image processing conditions and for generating processed image data.

5. The digital camera according to claim 4, further comprising a recording device for recording on a recording medium the RAW data outputted from the imaging device and the processed image data generated by the development device.

6. A print system for sending processed image data from a photo studio to a development station creating a photo print based on the processed image data, comprising:
the photo studio having an image processing device which performs image processing for proper printing on the processed image data obtained from the digital camera according to claim 4; and
the development station having a digital printer for directly receiving the image data processed by the image processing device and printing an image corresponding to the image data on a printing papers of a predetermined print size.

7. A print system for sending processed image data from a photo studio to a development station which creates a photo print based on the processed image data, comprising:
the photo studio having:
a digital camera for outputting RAW data;
a device which detects or sets photographic conditions when photographing with the digital camera at the photo studio;
a storage device which stores the image processing conditions linked to the photographic conditions on the photo studio obtained by the image processing method of digital images according to claim 1;
a development device which reads corresponding image processing conditions from the storage device based on the photographic conditions detected or set when photographing and performs to the RAW data outputted from the digital camera a development including the image processing according to the read image processing conditions so as to generate processed image data; and
an image processing device which performs image processing to properly print the processed image data generated by the development device;
and wherein the development station has a digital printer for directly receiving the image data processed by the image processing device and printing an image corresponding to the image data on a printing paper of a predetermined size.

8. The print system according to claim 6, wherein the photo studio has a backup device which backs up RAW data obtained from the digital camera.
